(19) United States
(12) Patent Application Publication
(10) Pub. No.: US 2024/0367422 A1
(43) Pub. Date: Nov. 7, 2024

(54) RECYCLE-READY LAMINATE FILM FOR FOOD AND LIQUID PACKAGING

(71) Applicant: Cheer Pack North America LLC, West Bridgewater, MA (US)

(72) Inventors: Steve Gosling, West Bridgewater, MA (US); Juned Khakhi, West Bridgewater, MA (US); Paul van den Hoonaard, West Bridgewater, MA (US)

(21) Appl. No.: 18/143,259

(22) Filed: May 4, 2023

(51) Int. Cl. B32B 27/08; B32B 7/12; B32B 27/18; B32B 27/30; B32B 27/32; B65D 75/26; B65D 75/58

(52) U.S. Cl. CPC B32B 27/08; B32B 7/12; B32B 27/18; B32B 27/306; B32B 27/32; B65D 75/26; B65D 75/5883; B32B 2250/05; B32B 2250/246; B32B 2255/10; B32B 2307/31; B32B 2307/4023; B32B 2307/412; B32B 2307/518; B32B 2439/46; B32B 2439/70; B65D 2575/586

(57) ABSTRACT

The instant disclosure relates to manufacturing of recycle-ready spouted or flat pouches for all types of liquid and viscous food and non-food products across a range of processes that include hot fill, retort, cold/ambient fill, and high-pressure processing. That is, embodiments herein include preparing pouches that are fully recyclable, and can withstand the many possible processing conditions under which spouted or flat pouches for all types of liquid and viscous food and non-food products may encounter. The pouches are formed from multi-layer laminate films made from polymer materials with an added compatibilizer component that make the polymer materials in the multi-layer films be compatible with recycling processes.

### FIELD

Illustrative embodiments of the invention generally relate to manufacturing spouted or flat pouches for all types of liquid and viscous food and non-food products that are fully recyclable and, more particularly, various embodiments of the invention relate to preparing multi-layered polymer laminate films that incorporate compounds that make the polymer films recyclable.

### BACKGROUND

The packaging for food and beverage consumer products may include flexible pouches, such as provided for juice pouches. These pouches must be flexible and keep the liquid from leaking out of the container. The pouches should also be able to preserve the product through shipping, warehousing, and displaying in the retail environment.

Increasingly, consumers also desire that the packaging be environmentally friendly. That is, there is a premium placed on packaging that can be readily recycled. In order for manufacturers to make packages ready for recycling, such as liquid pouches, careful attention must be paid to the film materials that make up the pouches.

Pouches are typically fabricated from thin film laminates that may include various layers that provide protection from air, that withstand shock and vibration, that can retain an ink image on the surface, and so on. In order to meet consumer demand for environmental considerations, the laminates should also be made from materials that are recyclable.

### SUMMARY OF VARIOUS EMBODIMENTS

In accordance with an embodiment of the invention, a recycle ready film for use in consumable item packaging includes a print web. The print web may include a film of bi-axially oriented polyethylene (BOPE) film having a top surface and a bottom surface, opposite the top surface. The print web may include a five color roto gravure print layer adjacent to the bottom surface of the BOPE layer. The recycle ready film may further include a sealant web. The sealant web may include a first linear low-density polyethylene (LLDPE) film, a first polyethylene film (PE), a first tie layer, and an ethylene-vinyl alcohol layer (EVOH). The sealant web may further include a second tie layer, a second PE film, and a second LLDPE film. The recycle ready film may further include an adhesive layer positioned between the five color roto gravure print layer and the first LLDPE film, such that the adhesive layer bonds the print web to the sealant web. The print web may further include a primer, having a top surface opposite a bottom surface. The top surface of the primer may be in contact with the bottom surface of the BOPE film. The five color roto gravure print layer may be deposited on the bottom surface of the primer. The primer may also be identified as a primer layer.

At least one of the PE layers, the EVOH layer, or the LLDPE layers may include a compatibilizer. The compatibilizer may include an anhydride and/or carboxylic acid functionalized ethylene/alpha-olefin interpolymer. The consumable item packaging may include a pouch. The consumable item may be at least one of a liquid, a viscous food, or a non-food product. The consumable item packaging may be recyclable.

In accordance with another embodiment of the invention, a laminate film includes: a first web, comprising: a first film comprising a first polymer material; the first film having a top surface and a bottom surface; and a color layer applied to the bottom surface of the first film; and a second web, comprising: a second film comprising a second polymer material, the second film having a top surface and a bottom surface; a third film comprising a third polymer material having a top surface in contact with the bottom surface of the second polymer film; a first tie layer, a top surface of the first tie layer adhered to a bottom surface of the third film; a fourth film comprising a fourth polymer material, a top surface of the fourth film adhered to a bottom surface of the tie layer; a second tie layer; a top surface of the second tie layer adhered to a bottom surface of the fourth film; a fifth film comprising the third polymer material, a top surface of the fifth film adhered to a bottom surface of the second tie layer; and a sixth film comprising the second polymer material, a top surface of the sixth film adhered to a bottom surface of the fifth film. The color layer may be a five color roto gravure print layer.

The first polymer material may include a bi-axially oriented polyethylene (BOPE) film. The second polymer material may include a linear low-density polyethylene (LLDPE) film. The third polymer material may include a polyethylene (PE) film. The fourth polymer material may include a ethylene-vinyl alcohol (EVOH) film.

At least one of the first polymer material, the second polymer material, the third polymer, or the fourth polymer may include a compatibilizer. The compatibilizer may include an anhydride and/or carboxylic acid functionalized ethylene/alpha-olefin interpolymer. The tie layer may include maleic-anhydride grafted polymer. The laminate film may be recyclable.

In accordance with another embodiment of the invention, a recycle ready laminate pouch for packaging liquid and viscous food and non-food products includes: a pouch panel folded upon itself such that a bottom edge of the pouch is formed of the folded panel; a pair of aligned side edges extending between the bottom edge and an upper edge opposite the bottom edge; a pair of side seals sealing the pair of side edges to form a pouch body; a pair of upper seals extending across the upper edge, each upper seal having one end adjacent each side seal and an opposite end adjacent a central portion of the pouch panel; and an opening device integrally formed in the central portion of the pouch body for accessing the liquid and viscous food and non-food products contained within the pouch. The opening device may be a fitment having a spout and a cap attachable to the spout.

In embodiments, the recycle ready laminate may include a multi-layer structure including a print web and a sealant web. The print web may include at least a first polymer layer comprising a first polyethylene material. The print web may also include at least one primer layer. The sealant web may include at least a second polymer layer comprising a polar material; at least a third polymer layer comprising a second polyethylene material; and at least one tie layer. The multi-layer structure may include an adhesive layer positioned between the print web and the sealant web, such that the adhesive layer adheres the print web to the sealant web. The print web may further include a color layer applied to a bottom surface of the at least one primer layer. The sealant web may further include at least a fourth polymer layer comprising a third polyethylene material.

The first polyethylene material may include a bi-axially oriented polyethylene film. The second polyethylene material may include a linear low-density polyethylene film. The third polyethylene material may include a polyethylene film. The polar material may include an ethylene-vinyl alcohol film. One or more of the first polyethylene material, the second polyethylene material, the third polyethylene material, or the polar material may include a compatibilizer. The compatibilizer may include an anhydride and/or carboxylic acid functionalized ethylene/alpha-olefin interpolymer. The pouch may be recyclable.

In accordance with yet another embodiment of the invention, a recycle ready laminate pouch for packaging liquid and viscous food and non-food products includes: a pouch panel folded upon itself such that a bottom edge of the pouch is formed of the folded panel; a pair of aligned side edges extending between the bottom edge and an upper edge opposite the bottom edge; pair of side seals sealing the pair of side edges to form a pouch body; an upper seal extending across the upper edge, the upper seal having one end adjacent each side seal and an opposite end adjacent a central portion of the pouch panel; and an opening device integrally formed in the central portion of the pouch body for accessing the liquid and viscous food and non-food products contained within the pouch. The opening device may be a fitment having a spout and a cap attachable to the spout.

In embodiments, the recycle ready laminate may include a multi-layer structure. The multi-layer structure may include a print web and a sealant web. The print web may include at least a first polymer layer comprising a first polyethylene material and may include at least one color layer. The color layer may be a roto gravure print layer. The color layer may include between 1 and 10 colors. The color layer may include between 4 colors and 7 colors.

The multi-layer structure may also include a sealant web. The sealant web may include at least a second polymer layer comprising a polar material, at least a third polymer layer comprising a second polyethylene material, at least one tie layer. The multi-layer structure may include an adhesive layer positioned between the print web and the sealant web, such that the adhesive layer adheres the print web to the sealant web.

The print web may further include a primer layer applied to a bottom surface of the first polymer layer. The sealant web may further include at least a fourth polymer layer comprising a third polyethylene material. The first polyethylene material may include a bi-axially oriented polyethylene film. The second polyethylene material may include a linear low-density polyethylene film. The third polyethylene material may include a polyethylene film. The polar material may include an ethylene-vinyl alcohol film.

The first polyethylene material may include a compatibilizer. The second polyethylene material may include a compatibilizer. The third polyethylene material may include a compatibilizer. The polar material may include a compatibilizer. The compatibilizer may include an anhydride and/or carboxylic acid functionalized ethylene/alpha-olefin interpolymer. The pouch may be recyclable.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1A schematically shows a non-limiting embodiment of forming a multi-layer recycle ready film,

FIG. 1B schematically shows a non-limiting embodiment of a length of recycle ready film that that is prepared for being formed into a recycle ready pouch,

FIG. 1C schematically shows a non-limiting embodiment of pressing the edges of a recycle ready film to form a recycle ready pouch,

FIG. 1D schematically shows a non-limiting embodiment of a recycle ready pouch,

FIG. 2 schematically shows a non-limiting embodiment of components of a multi-layer recycle ready film,

FIG. 3 schematically shows a non-limiting embodiment of components of a multi-layer recycle ready film,

FIG. 4 schematically shows a non-limiting embodiment of adhering two webs together to form a multi-layer recycle ready film,

FIG. 5A schematically shows a non-limiting embodiment of adhering two multi-layer recycle ready film together to form a recycle ready pouch.

FIG. 5B schematically shows another non-limiting embodiment of adhering two multi-layer recycle ready film together to form a recycle ready pouch.

### DESCRIPTION OF ILLUSTRATIVE EMBODIMENTS

In embodiments, the instant disclosure relates to manufacturing of recycle-ready spouted or flat pouches for all types of liquid and viscous food and non-food products across a range of processes that include hot fill, retort, cold/ambient fill, and high-pressure processing. That is, embodiments herein include preparing pouches that are fully recyclable, and can withstand the many possible processing conditions under which spouted or flat pouches for all types of liquid and viscous food and non-food products may encounter. The pouches are formed from multi-layer laminate films made from polymer materials with an added compatibilizer component that make the polymer materials in the multi-layer films be compatible with recycling processes.

In embodiments, the instant disclosure describes methods, systems, and materials (e.g., laminates) that may be used to make materials for pouches, as well as the actual pouches that are: recyclable, that can be processed on a pouch machine; that have a material structure that facilitates sealing in a fitment (and cap); and allow for a hot-fill process that can preserve all types of liquid and viscous food and non-food products. Details of illustrative embodiments are discussed below.

In embodiments, a pouch is formed from a multi-layer film that is made by combining two or more webs that have different functions. A first web may be designed to provide an exterior surface of a pouch, while a second web may be designed to provide an interior surface of the pouch. The exterior web and the interior web may be joined so that they form a single web that may be manufactured into a pouch.

The first web, an exterior web, may have qualities that allow it to have text and/or graphic designs (e.g., printed material) printed on it that are visible from the outside of the pouch. As such, it may be called a print web. This print web providing the exterior surface of the pouch may be a multi-layer web that is fabricated to provide a transparent polymer material on the outer surface of the web that at least in part provides for allowing printed material to be reverse printed on an inside surface the transparent polymer material so that the text and/or graphic designs may be visible through the transparent polymer material. By reverse printing the printed material on the inside surface of the transparent polymer material, the transparent polymer material prevents the text and/or graphic designs from being scratched or removed.

A second web may have qualities that prevent air (e.g., oxygen and/or water vapor) from penetrating into the pouch, and thus degrading to product inside (e.g., sealing the pouch). As such, this web may be called a sealant web. It may form the inside surface of the pouch, and provide the primary structural qualities of the pouch. The sealant web may be multi-layer web that includes different polymer materials with tie layers (e.g., bonding layers) positioned between the various polymer layers.

The print web and the sealant web may be joined by applying an adhesive between the webs and adhering the webs together. The joined print web and sealant web form a multi-layer film that may be fabricated into a pouch. The pouch may be flat, or may have a spout (e.g., a spouted pouch) that enables a cap to be coupled with the spout.

The multi-layer pouch may be manufactured to be recyclable by including a compatibilizer component that make the polymer materials in the multi-layer films be compatible with recycling processes. By inclusion of the compatibilizer components in the polymer materials prior to formation of the webs, the polymer materials in the multi-layer films become recyclable in recycling streams with compromising the recycled product. That is, disclosed are recycle ready multi-layer films that may be fabricated into recycle ready pouches for all types of liquid and viscous food and non-food products.

### Compatibilizer Component

The compatibilizer component may include an anhydride and/or carboxylic acid functionalized ethylene/alpha-olefin interpolymer. The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The term, “ethylene/α-olefin interpolymer,” as used herein, refers to an interpolymer that comprises, in polymerized form, a majority amount of ethylene monomer (based on the weight of the interpolymer), and at least one α-olefin.

The term “anhydride and/or carboxylic acid functionalized ethylene/alpha-olefin interpolymer,” as used herein, refers to an ethylene/alpha-olefin interpolymer that comprises at least one anhydride group and/or at least one acid group (for example, —COOH formed by the hydrolysis of an anhydride) linked by a covalent bond.

The compatibilizer may be present in the any of the polymer material layers in the range of from 1 weight percent to 35 weight percent. Any and all ranges from 1 to 35 weight percent are included herein and disclosed herein, for example, the compatibilizer can be present in the polymer material in the range of from 5 to 30 weight percent, 10 to 25 weight percent, or 15 to 22 weight percent.

The base polymer used to form the anhydride and/or carboxylic acid functionalized ethylene/α-olefin interpolymer is an ethylene/α-olefin interpolymer. In various embodiments, alpha olefins are C3-C20 alpha (α)-olefins. Any and all ranges between C3 and C20 are included herein and disclosed herein, for example, the α-olefins are C3-C10 α-olefins. Examples of α-olefins that can be used in the present invention include, but are not limited to propylene, 1-butene, 1-pentene, 1-hexene, 1-heptene and 1-octene, and more preferably include propylene, 1-butene, 1-hexene and 1-octene. In various embodiments, the anhydride and/or carboxylic acid functionalized ethylene/alpha-olefin interpolymer has a melt viscosity in the range of from 2000 cP to 50,000 cP at 350° F. (177° C.). Any and all ranges between 2000 cP and 50,000 cP are included herein and disclosed herein, for example, the melt viscosity can be in the range of from 3000 cP to 40,000 cP, from 4000 cP to 30,000 cP, or from 5000 cP to, 20,000 cP, at 350° F. (177° C.).

In one embodiment, the anhydride and/or carboxylic acid functionalized ethylene/alpha-olefin interpolymer has a density from 0.855 g/cm3 to 0.940 g/cm3. Any and all ranges from 0.855 g/cm3 to 0.940 g/cm3 are included herein and disclosed herein, for example, the anhydride and/or carboxylic acid functionalized ethylene/alpha-olefin interpolymer can have a density from 0.860 g/cm3 to 0.900 g/cm3, from 0.860 gm/cm3 to 0.895 gm/cm3, from 0.865 g/cm3 to 0.890 g/cm3, or from 0.865 g/cm3 to 0.880 g/cm3.

In one embodiment, the anhydride and/or carboxylic acid functionalized ethylene/alpha-olefin interpolymer has a molecular weight distribution (MWD) (Mw/Mn) from 1.1 to 5.0. Any and all ranges from 1.1 to 5.0 are included herein and are disclosed herein, for example, the anhydride and/or carboxylic acid functionalized ethylene/alpha-olefin interpolymer can have a MWD of from 1.3 to 4.0, 1.5 to 2.8, or 2.0 to 2.5, or from 2.0 to 3.0.

In one embodiment, the anhydride and/or carboxylic acid functionalized ethylene/alpha-olefin interpolymer has a weight average molecular weight (Mw) in the range of from 2000 g/mole to 50,000 g/mole. Any and all ranges from 2000 g/mole to 50,000 g/mole are included herein and disclosed herein, for example, the anhydride and/or carboxylic acid functionalized ethylene/alpha-olefin interpolymer can have a Mw in the range of from 3000 g/mole to 40,000 g/mole, or from 4000 g/mole to 30,000 g/mole.

In one embodiment, the anhydride and/or carboxylic acid functionalized ethylene/alpha-olefin interpolymer has a melt index (I2), or calculated melt index (I2) (2.16 kg, 190 C), in the range of from 300 g/10 min to 1500 g/10 min. Any and all ranges between 300 g/10 min and 1500 g/10 min are included herein and disclosed herein, for example, the anhydride and/or carboxylic acid functionalized ethylene/alpha-olefin interpolymer can have a melt index (I2), or calculated melt index (I2) in the range of from 400 g/10 min to I200 g/10 min, or from 500 g/10 min to 1000 g/10 min.

In one embodiment, the anhydride and/or carboxylic acid functionalized ethylene/alpha-olefin interpolymer has a percent crystallinity, as determined by DSC, in the range of from 2 percent to 40 percent. Any and all ranges from 2% to 40% are included herein and disclosed herein, for example, the anhydride and/or carboxylic acid functionalized ethylene/alpha-olefin interpolymer can have a percent crystallinity in the range of from 5% to 30%, from 10% to 25%, or from 15% to 20%.

In an embodiment, the anhydride and/or carboxylic acid functionalized ethylene/alpha-olefin interpolymer has a melt viscosity (177° C.) less than, or equal to, 200,000 cP and a density from 0.855 to 0.94 g/cc.

An example of a functionalized ethylene/α-olefin copolymer is RETAIN 3000 available from The Dow Chemical Company.

### Print Web

In embodiments, the print web includes a transparent polymer material (e.g., Poly Mat 1). This polymer material may be bi-axially oriented polyethylene (BOPE). BOPE is a polyethylene (e.g., PE) film that has been stretched (e.g., oriented) in two directions: one direction in the direction of the feed of the machine; and the other direction perpendicular to the feed of the machine. BOPE films have improved optics and sealability properties relative to standard PF films. In embodiments, the transparent polymer material may be selected from other transparent polymer materials.

The BOPE layer may have a compatibilizer component included in the PE material that is formed into the BOPE film. BOPE films that include the compatibilizer component are recyclable and may be included in recycle ready multi-layer films.

In embodiments, the printed material (e.g., text and/or graphic designs) is applied by Gravure printing. The Gravure printing may apply five-color images in a reverse-print manner to the inside surface of the BOPE layer.

It is surprising that a combination of a multi-layer print web having a transparent polymer layer, such as BOPE, and a color print layer can be prepared to be recyclable by the addition of a compatibilizer component to the transparent polymer layer.

In embodiments, the print web may include a primer layer that is deposited on the Poly Mat 1 layer. The primer (e.g., primer layer) is provided on the Poly Mat 1 layer in order to improve the adhesion and color properties of the printed material on the inside surface of the transparent polymer material. Primer may be added to improve adhesion between ink and transparent polymer material, forming a strong linkage between the two. The primer layer also has in important role in controlling how the ink interacts with the transparent polymer material once the printed ink land is applied to it.

In embodiments, the printed material (e.g., text and/or graphic designs) is applied by Gravure printing. The Gravure printing may apply five-color images in a reverse-print manner to the primer layer that has been applied to the inside surface of the BOPE layer.

It is surprising that a combination of a multi-layer print web having a transparent polymer layer, such as BOPE, a primer layer, and a color print layer can be prepared to be recyclable by the addition of a compatibilizer component to the transparent polymer layer.

### Sealant Web

In embodiments, the sealant web includes a barrier layer sandwiched between one or more layers of different polymer materials in the multi-layer sealant web structure. The barrier layer may be formed from ethylene-vinyl alcohol (e.g., EVOH) to form a film that is a flexible, crystal clear, glossy thermoplastic copolymer. This material is polar and has excellent flex-crack resistance, and exhibits a high resistance to hydrocarbons, oils and organic solvents. EVOH is known for having some of the best barrier resistance to gases such as oxygen, nitrogen, and carbon dioxide which makes it particularly suited for packaging food, drugs, cosmetics, and other perishable products. In embodiments, the barrier layer may be formed from polymeric materials other than EVOH.

The EVOH layer may have a compatibilizer component included in the EVOH material that is formed into the EVOH film. EVOH films that include the compatibilizer component are recyclable, and may be included in recycle ready multi-layer films.

In embodiments, the sealant web may contain one or more polyethylene (e.g., PE) layers. The PE layers may form layers that are part of the sandwich that is below and above the EVOH layers in the multi-layer film structure. PE film is a thin plastic sheeting most often provided in rolls that exhibit excellent tape adhesion and lightweight durability. PE film is resistant to water, rot, wrinkles, and chemicals, PE film can be reused and stands up to UV degradation for several years.

The PE layer may have a compatibilizer component included in the PE material that is formed into the PE film. PE films that include the compatibilizer component are recyclable, and may be included in recycle ready multi-layer films.

In embodiments, the sealant web may contain one or more linear low-density polyethylene (LLDPE) films. The LLDPE films may form layers that are part of the sandwich that is below and above the EVOH layers in the multi-layer film structure. The LLDPE layers may be in addition to, or in place of PE layers. LLDPE is very flexible and elongates under stress. It resists stress cracking, and has good resistance to chemicals.

The LLDPE layer may have a compatibilizer component included in the LLDPE material that is formed into the LLDPE film. LLDPE films that include the compatibilizer component are recyclable, and may be included in recycle ready multi-layer films.

In embodiments, the sealant web may contain one or more tie layers. The tie layers are polymers positioned in the multi-layer sealant web immediately adjacent the barrier layer, such as an EVOH layer. The tie layers provide excellent adhesion to many polar polymers because they form strong hydrogen and polar bonds with many polar polymers, such as EVOH. Thus, the tie layer provides an adhesive layer that bonds the EVOH layer (e.g., barrier layer) to the adjacent polymer material layers.

In embodiments, the tie layer comprises a maleic-anhydride grafted polymer. The maleic-anhydride grafted polymer has a melt index of less than 50 dg/min. Furthermore, the addition of low levels of maleic-anhydride to a polar polymer may enable compatibilization of the polymer, but can diminish the properties of the polar polymer. In embodiments, the tie layer does not contain the compatibilizer component.

It is surprising that a combination of a multi-layer sealant web having a barrier layer, such as EVOH, at least one tie layer, and at least one polymer material layer can be prepared to be recyclable by the addition of a compatibilizer component to the EVOH layer and the polymer material layers.

### Multi-Layer Recycle Ready Film

The print web and the sealant web may be adjoined together by the addition of an adhesive between the two webs to form a multi-layer (e.g., laminate) film. When a compatibilizer component is added to the polymer material layers, the multi-layer film becomes a recycle ready film. That is, the compatibilizer component changes the processing properties of the polymer material layers to be compatible with other polymers in the polymer waste stream.

### Recycle Ready Pouch

The multi-layer recycle ready film may be processed into a recycle ready pouch for all types of liquid and viscous food and non-food products. That is, in a surprising result, it is disclosed to manufacture a pouch for all types of food and non-food products that is fully recyclable and is suitable for adding to a recycling waste stream.

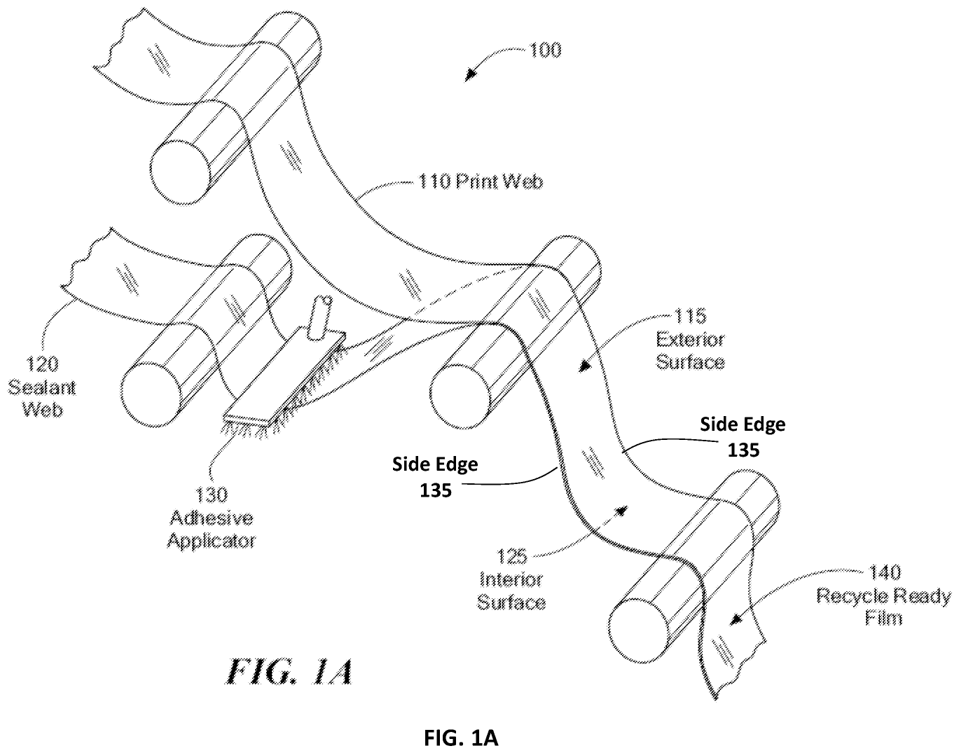

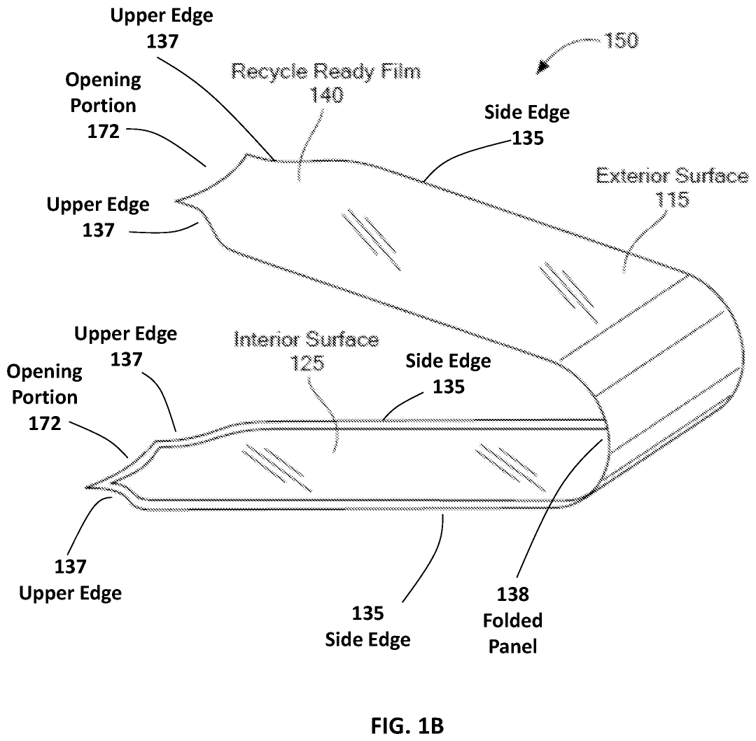

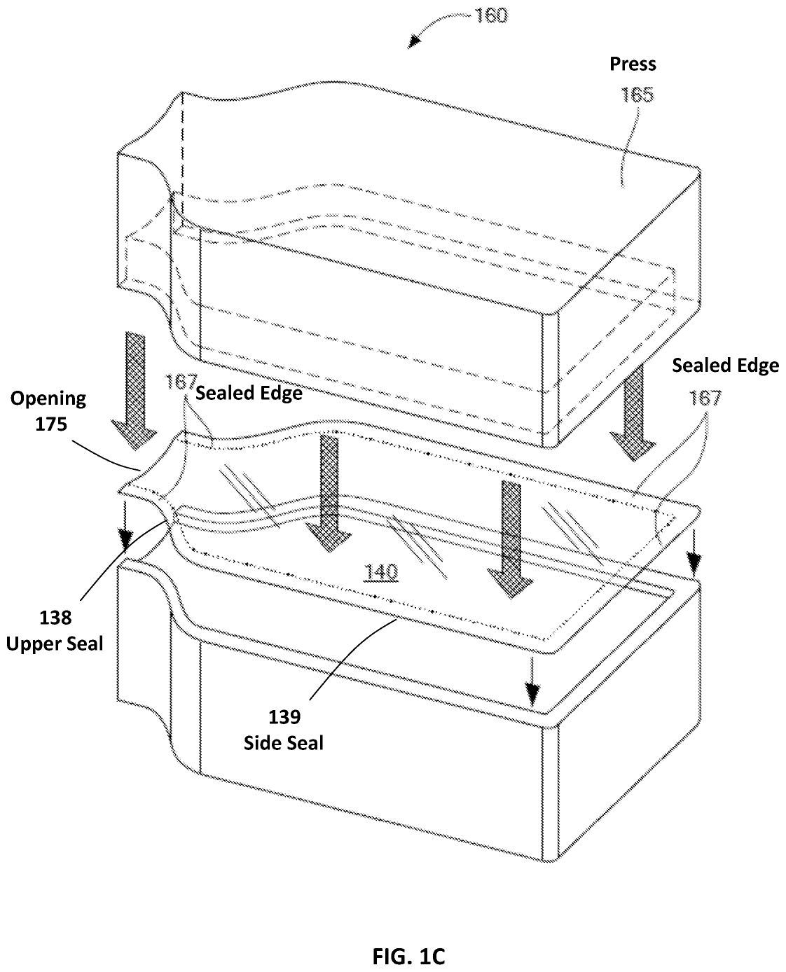

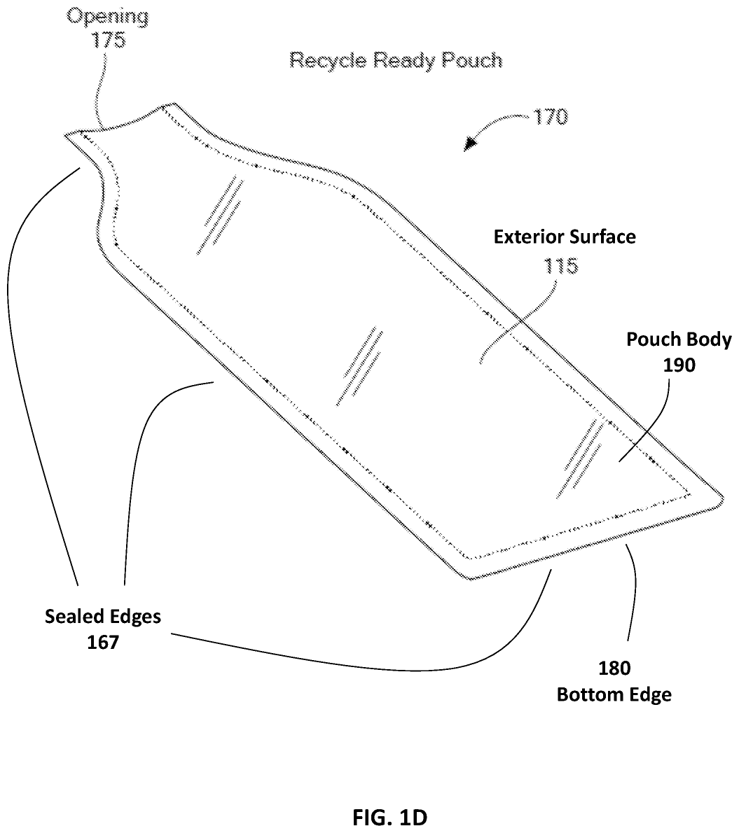

FIG. 1A schematically shows a non-limiting embodiment 100 of forming a multi-layer recycle ready film 140 from a print web 110 and a sealant web 120. The print web 110 and the sealant web 120 are affixed to each other by an adhesive applied by an adhesive applicator 130. The recycle ready film 140 has an exterior surface 115 formed from the print web 110, an interior surface 125 formed from the sealant web 120, and side edges 135.

FIG. 1B schematically shows a non-limiting embodiment of a length of recycle ready film 150 that is prepared for being formed into a recycle ready pouch. The recycle ready film 140 may be folded upon itself at the folded panel 138 so that the side edges 135 of opposing interior surfaces 125 may be aligned. The film has shaped upper edges 137 that are opposite the folded panel 138. An opening portion 172 is formed by the upper edges 137.

FIG. 1C schematically shows a non-limiting embodiment 160 of pressing the side edges 135 and the upper edges 137 of the folded recycle ready film 140 to form a heat seal bond around the edges of the recycle ready film 140, in order to form a recycle ready pouch 170, as shown in FIG. 1D. A press 165 applies pressure to the edges of the recycle ready film that has been folded upon itself.

Once aligned, the side edges 135 may be secured by a sealing means, such as a weld, melt bonding, or by a heat seal bond. The side edges 135 may be pressed together by applying pressure and heat to the edges that are to be bonded together to form a sealed edge 167. This may be a first stage of forming the heat seal bonds. The press may operate at a predetermined temperature and apply a predetermined pressure to form the seal on the edges of the pouch. The interior surfaces 125 of the edges that are pressed together form a heat seal bond (e.g., also known as a weld or melt bonding). The heat seal bond may be formed by interaction between the like surfaces of the interior surfaces 125 of the recycle ready films 140. An upper seal 138 may extend across an upper edge 137 of the pouch. The upper seal 138 may have one end adjacent each side seal 139 and an opposite end adjacent to a central portion of the pouch panel. An opening 175 may be integrally formed in the central portion of the pouch body for accessing the liquid, the viscous food, and/or the non-food products contained within the pouch. In alternative embodiments, an adhesive may be applied to an outer edge of the interior surface 125 of the recycle ready film 140.

In embodiments, the press 165 may apply heat and pressure to the recycle ready film 140 in a first stage of forming the pouch. In embodiments, the press may apply pressure without applying heat in a second stage of forming the pouch. That is, in a second stage in forming the heat seal bonds, pressure may still be applied to the film without additional heat being provided. In embodiments, the press 165 may be actively cooled during the second stage of forming the pouches.

In the first stage, the press 165 may apply heat and pressure to the recycle ready film 140. In embodiments, the duration of active heating of the press may be less than, or greater than, or equal to the duration of pressure application.

In the second stage, the press 165 may apply pressure to the recycle ready film 140. In embodiments, the duration of cooling of the press may be less than, 15 greater than, or equal to the duration of pressure application. In embodiments, the press 165 may be actively cooled during the second stage of forming the pouches, or it may be allowed to cool to room temperature following the operation at an elevated temperature during operation of the first stage.

FIG. 1D schematically shows a non-limiting embodiment of a recycle 20 ready pouch 170. The recycle ready pouch 170 has a pouch body 190, sealed edges 167, a bottom edge 180, and an opening 175, opposite the bottom edge. 180. In embodiments, the recycle ready pouch 170 may have a flat opening. In embodiments, the opening may be flat, a spout and/or a threaded spout. In embodiments, the recycle ready pouch may be in a general shape of a box.

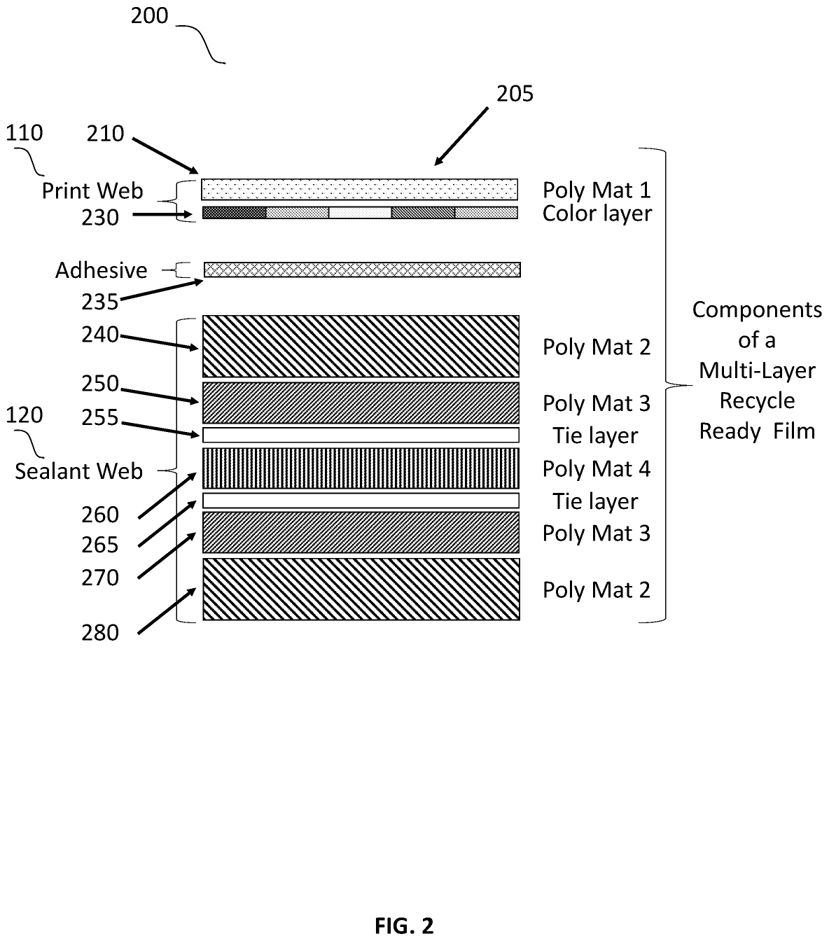

FIG. 2 schematically shows a non-limiting embodiment of components of a multi-layer recycle ready film 200. In embodiments, the multi-layer recycle ready film 200 includes a print web 110. The print web 110 may include a polymer transparent film of a first polymer material 210 (e.g., Poly Mat 1). The transparent polymer material, Poly Mat 1, may be a bi-axially oriented polyethylene (BOPE) film. BOPE provides clear transparency, structural strength, adhesion properties, and can withstand elevated heat-sealing temperatures. In embodiments of recycle ready films, an amount of a compatibilizer component may be added to the BOPE prior to being rolled out into a film, thereby making the BOPE film compatible with recycling processes.

The BOPE layer has top surface 205 and a bottom surface that is opposite the top surface. The top surface 205 of the BOPE provides the outer surface of a recycle ready pouch.

The print web 110 includes a color layer 230 that is applied to the bottom surface Poly Mat 1 layer 220. The color layer 230 provides the printed material (e.g., text and/or graphic designs) that is visible on the outer packaging. It is applied by Gravure printing. The Gravure printing may apply five-color images in a reverse-print manner to the Poly Mat 1 layer that has been applied to the inside surface of the BOPE layer.

The multi-layer recycle ready film 200 also includes a sealant web 120. The sealant web 120 includes a barrier layer 260 comprising polymer material 4 (e.g., Poly Mat 4). The barrier layer may be formed from ethylene-vinyl alcohol (e.g., EVOH) to form a film that is a flexible, crystal clear, glossy thermoplastic copolymer. EVOH provides resistance to gases such as oxygen, nitrogen, and carbon dioxide, which makes it particularly suited for packaging food, drugs, cosmetics, and other perishable products. In embodiments of recycle ready films, an amount of a compatibilizer component may be added to the EVOH prior to being rolled out into a film, thereby making the EVOH film compatible with recycling processes.

In the non-limiting embodiment shown FIG. 2, the barrier layer 260 has tie layers 255 and 265 applied on the top and bottom surfaces, respectively, of the barrier layer 260. The tie layers provide excellent adhesion to polar polymers, such as EVOH, and provide an adhesive layer that bonds the EVOH layer (e.g., barrier layer 260) to adjacent polymer material layers.

Two polymer material layers (e.g., Poly Mat 3), 250 and 270, are adjacent to the tie layers 255 and 265, respectively. The polymer materials of Poly Mat 3 may be polyethylene (e.g., PE), or some other polymer material. PE films are resistant to water, rot, wrinkles, and chemicals. In embodiments of recycle ready films, an amount of a compatibilizer component may be added to the PE prior to being rolled out into the films, thereby making the PE films compatible with recycling processes.

Continuing with the non-limiting embodiment shown FIG. 2, two polymer material layers (e.g., Poly Mat 2), 240 and 280, are adjacent to the Poly

Lat 3 layers 250 and 270, respectively. The polymer materials of Poly Mat 2 may be linear low-density polyethylene (LLDPE) films, or some other polymer material. LLDPE films resist stress cracking and have good resistance to chemicals. In embodiments of recycle ready films, an amount of a compatibilizer component may be added to the LLDPE prior to being rolled out into the films, thereby making the LLDPE films compatible with recycling processes.

The components of multi-layer recycle ready film of FIG. 2 also includes an adhesive layer 235 positioned between the print web 110 and the sealant web 120. The adhesive layer 235 adheres the bottom surface of the color layer 230 of the print web 110 to the top surface of Poly Mat 2 240 of the sealant web 120. The print web 110, the adhesive layer 235, and the sealant web 120 are heated and rolled into a multi-layer recycle ready film, as shown schematically in FIG. 1.

In embodiments, the print web 110 may include a primer layer (e.g., primer) that is applied to the bottom surface of the BOPE layer. The primer layer may be provided on the Poly Mat 1 layer in order to improve the adhesion and color properties of the printed material on the inside surface of the transparent polymer material Poly Mat 1.

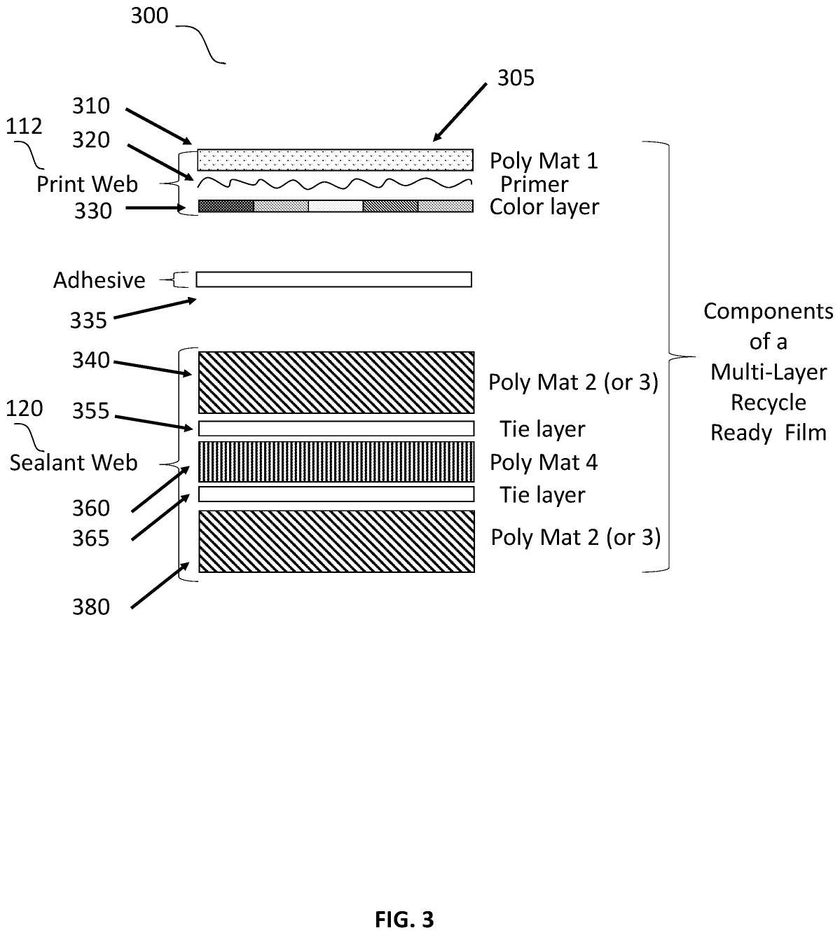

FIG. 3 schematically shows a non-limiting embodiment of components of a multi-layer recycle ready film 300. In embodiments, the multi-layer recycle ready film 300 includes a print web 112. The print web 112 may include a polymer transparent film of a first polymer material 310 (e.g., Poly Mat 1). The transparent polymer material, Poly Mat 1, may be a bi-axially oriented polyethylene (BOPE) film. BOPE provides clear transparency, structural strength, adhesion properties, and can withstand elevated heat-sealing temperatures. In embodiments of recycle ready films, an amount of a compatibilizer component may be added to the BOPE prior to being rolled out into a film, thereby making the BOPE film compatible with recycling processes.

The BOPE layer has top surface 305 and a bottom surface that is opposite the top surface. The top surface 305 of the BOPE provides the outer surface of a recycle ready pouch.

In the non-limiting embodiment of the print web 112 shown in FIG. 3, the print web 112 includes a primer layer 320 that is applied to the bottom surface of the BOPE layer. (The inclusion of a primer layer is optional in the print webs.) The optional primer layer 320 is provided on the Poly Mat 1 layer in order to improve the adhesion and color properties of the printed material on the inside surface of the transparent polymer material Poly Mat 1.

The print web 112 includes a color layer 330 that is applied to the bottom surface primer layer 320. The color layer 330 provides the printed material (e.g., text and/or graphic designs) that is visible on the outer packaging. It is applied by Gravure printing. The Gravure printing may apply five-color images in a reverse-print manner to the primer layer that has been applied to the inside surface of the BOPE layer.

The multi-layer recycle ready film 300 also includes a sealant web 120. In embodiments, the sealant web 120 includes a barrier layer 360 comprising polymer material 4 (e.g., Poly Mat 4). The barrier layer may be formed from ethylene-vinyl alcohol (e.g., EVOH) to form a film that is a flexible, crystal clear, glossy thermoplastic copolymer. EVOH provides resistance to gases such as oxygen, nitrogen, and carbon dioxide, which makes it particularly suited for packaging food, drugs, cosmetics, and other perishable products. In embodiments of recycle ready films, an amount of a compatibilizer component may be added to the EVOH prior to being rolled out into a film, thereby making the EVOH film compatible with recycling processes.

In the non-limiting embodiment shown FIG. 3, the barrier layer 360 has tie layers 355 and 365 applied on the top and bottom surfaces, respectively, of the barrier layer 360. The tie layers provide excellent adhesion to polar polymers, such as EVOH, and provide an adhesive layer that bonds the EVOH layer (e.g., barrier layer 360) to adjacent polymer material layers.

Two polymer material layers (e.g., Poly Mat 2 or Poly Mat 3), 340 and 360, are adjacent to the tie layers 355 and 365, respectively. The polymer materials of Poly Mat 2 may be linear low-density polyethylene (LLDPE) films, or some other polymer material. LLDPE films resist stress cracking and have good resistance to chemicals. In embodiments of recycle ready films, an amount of a compatibilizer component may be added to the LLDPE prior to being rolled out into the films, thereby making the LLDPE films compatible with recycling processes. The polymer materials of Poly Mat 3 may be polyethylene (e.g., PE), or some other polymer material. PE films are resistant to water, rot, wrinkles, and chemicals. In embodiments of recycle ready films, an amount of a compatibilizer component may be added to the PE prior to being rolled out into the films, thereby making the PE films compatible with recycling processes.

The components of multi-layer recycle ready film of FIG. 3 also includes an adhesive layer 335 positioned between the print web 110 and the sealant web 120. In embodiments, the adhesive layer 335 adheres the bottom surface of the color layer 330 of the print web 110 to the top surface of Poly Mat 2 340 of the sealant web 120. In embodiments, the adhesive layer 335 adheres the bottom surface of the color layer 330 of the print web 110 to the top surface of Poly Mat 3 340 of the sealant web 120. The print web 110, the adhesive layer 335, and the sealant web 120 are heated and rolled into a multi-layer recycle ready film, as shown schematically in FIG. 1.

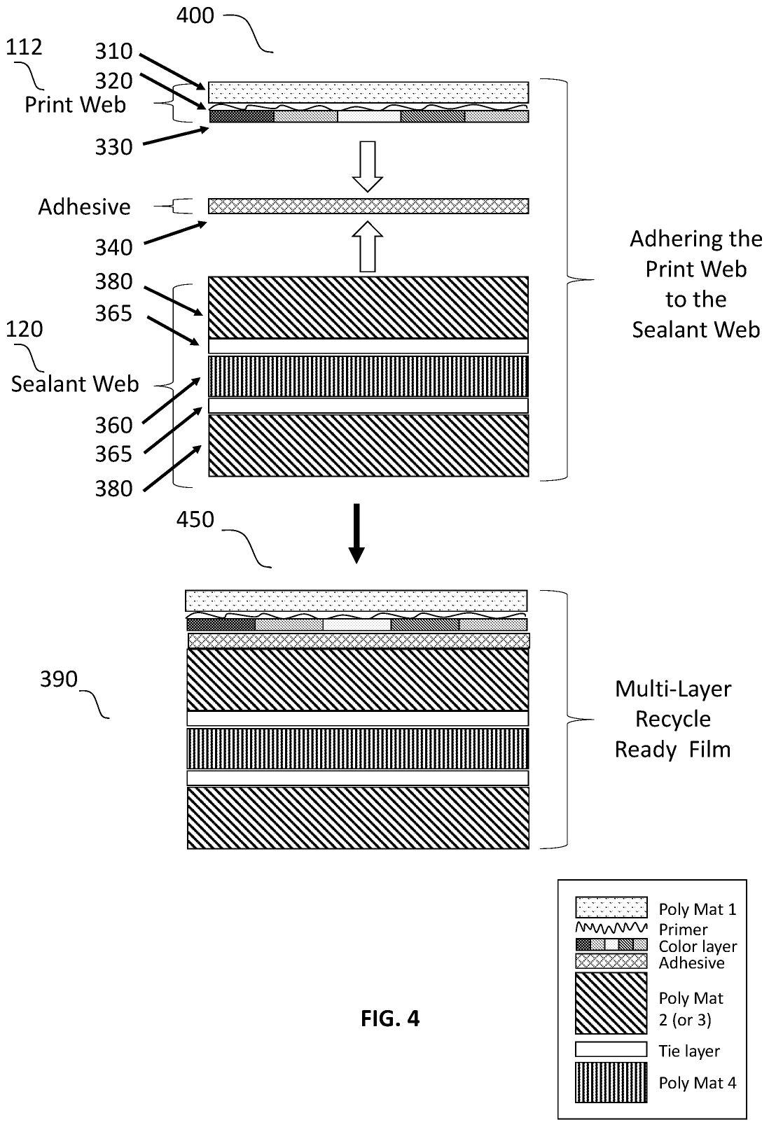

FIG. 4 schematically shows a non-limiting embodiment 400 of adhering two webs together to form a multi-layer recycle ready film. The embodiment shown in FIG. 4 illustrates 450 adhering print web 112 to sealant web 120 with an adhesive positioned between the print web 112 to sealant web 120 to form a multi-layer recycle ready film 390. Also shown in the non-limiting embodiment of FIG. 4, a optional primer layer 320 is present in the print web 112. In embodiments, the top 380 and bottom 380 layers of the sealant web 120 may be selected to be either Poly Mat 2, Poly Mat 3, or some other transparent polymer. In embodiments, the adhesive is applied from a sprayer (e.g., adhesive applicator 130) in a roll system, as shown in the non-limiting illustration of FIG. 1A.

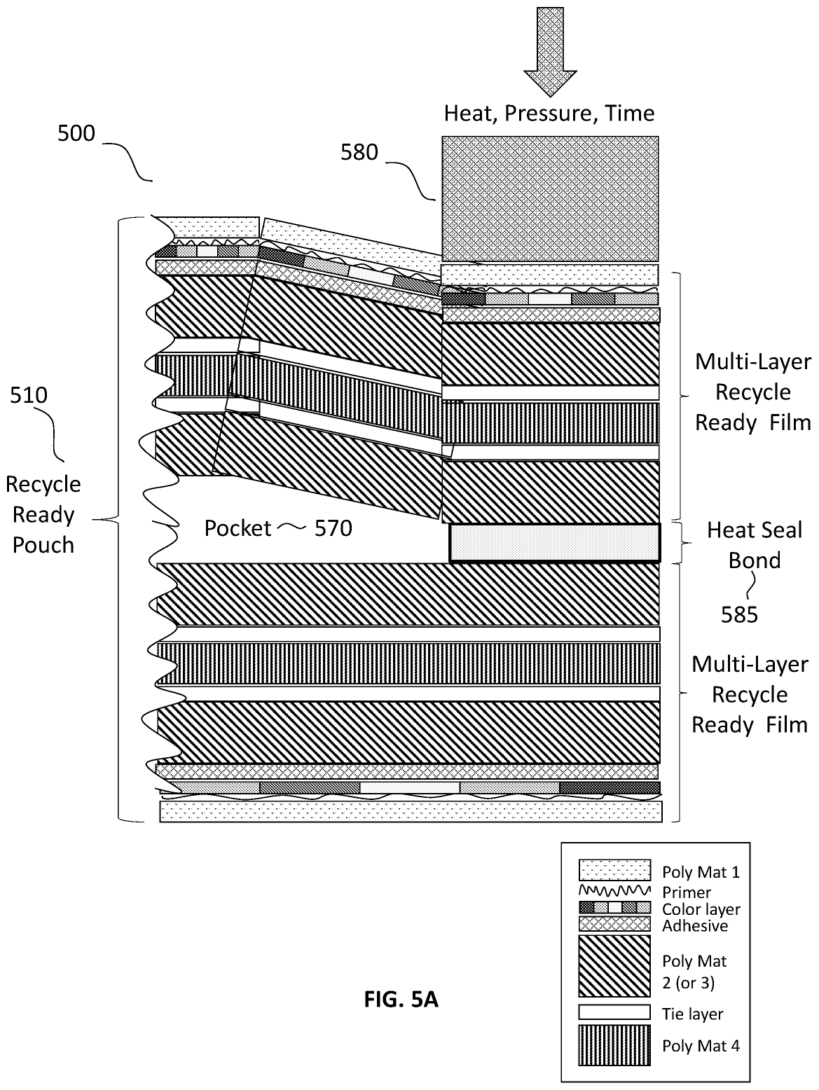

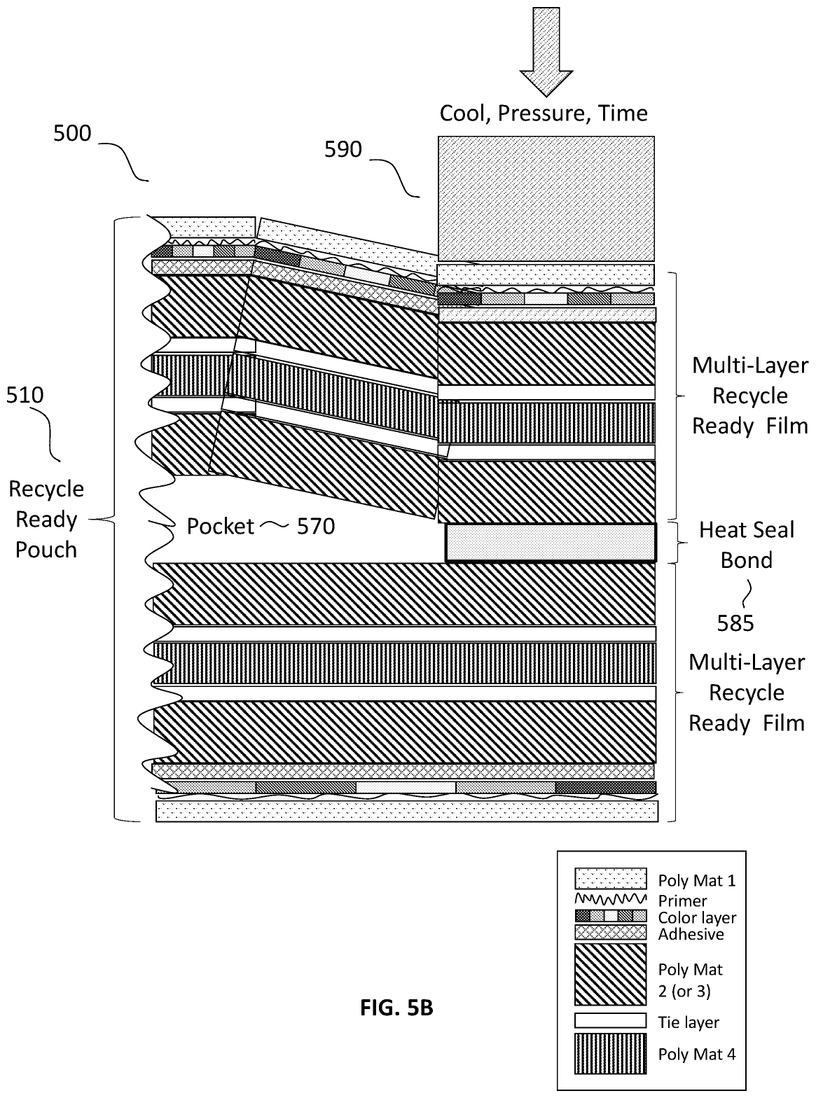

FIGS. 5A and 5B schematically show a non-limiting embodiment of adhering inside edges of two portions of multi-layer recycle ready film together to form a recycle ready pouch 510. The recycle ready pouch has a pocket 570 for retaining liquid and viscous food and non-food products. In FIG. 5A, heat and pressure are applied for a duration of time by a heated press 580 to the inside edges of two portions of multi-layer recycle ready film to form a heat seal bond 585. The press 580 may apply heat and pressure to the recycle ready film. The pressure may be applied for a duration of time. In embodiments, the duration of active heating of the press may be less than, or greater than, or equal to the duration of pressure application. In embodiments, an adhesive may be positioned between the inside edges of the inside edges of two portions of multi-layer recycle ready film.

In FIG. 5B, pressure is applied for a duration of time by an unheated press 590 to the inside edges of two portions of multi-layer recycle ready film to cool the heat seal bond 585, and allow the heat seal bond 585 to return to room temperature. That is, the press is not actively heated during the application of pressure during cooling of the press and the recycle ready pouch. In embodiments, the duration of cooling of the press may be less than, or greater than, or equal to the duration of pressure application.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A recycle ready film for use in consumable item packaging, comprising:
a print web, comprising:
a first polyethylene (PE) film; and
a color print layer printed onto a bottom surface of the polymer film; and
a sealant web coupled to the color print layer, the sealant web comprising a plurality of polymer films, wherein the plurality of polymer films comprises at least one linear low-density polyethylene (LLDPE) film, a second PE film, at least one tie layer, and at least one ethylene-vinyl alcohol (EVOH) layer.

2. The recycle ready film of claim 1, further comprising:
an adhesive layer positioned between the print web and the sealant web, wherein:
the adhesive layer bonds the print web to the sealant web, and
the sealant web is adhered to the color print layer.

3. The recycle ready film of claim 1, wherein at least one of the PE films, the EVOH layer, or the LLDPE film comprise a compatibilizer.

4. The recycle ready film of claim 3, wherein the compatibilizer comprises an anhydride and/or carboxylic acid functionalized ethylene/alpha-olefin interpolymer.

5. The recycle ready film of claim 1, wherein:
the consumable item packaging comprises a pouch; and
the consumable item is at least one of a liquid, a viscous food, or a non-food product.

6. The recycle ready film of claim 1, wherein:
the print web further comprises a primer, having a top surface opposite a bottom surface;
the first PE film is a bi-axially oriented polyethylene (BOPE) film;
the top surface of the primer is in contact with the bottom surface of the BOPE film; and
the five color roto gravure print layer is deposited on the bottom surface of the primer.

7. The recycle ready film of claim 5, wherein the consumable item packaging is recyclable.

8. A laminate film, comprising;
a first web, comprising:
a first film comprising a first polymer material; the first film having a top surface and a bottom surface; and
a color layer applied to the bottom surface of the first film; and
a second web, comprising:
a second film comprising a second polymer material, the second film having a top surface and a bottom surface;
a third film comprising a third polymer material having a top surface in contact with the bottom surface of the second polymer film;
a first tie layer, a top surface of the first tie layer adhered to a bottom surface of the third film;
a fourth film comprising a fourth polymer material, a top surface of the fourth film adhered to a bottom surface of the tie layer;
a second tie layer; a top surface of the second tie layer adhered to a bottom surface of the fourth film;
a fifth film comprising the third polymer material, a top surface of the fifth film adhered to a bottom surface of the second tie layer; and
a sixth film comprising the second polymer material, a top surface of the sixth film adhered to a bottom surface of the fifth film.

9. The laminate film of claim 8, wherein:
the first polymer material comprises at least one of a bi-axially oriented polyethylene (BOPE) film or a machine direction oriented polyethylene (MDOPE) film;
the second polymer material comprises linear low-density polyethylene (LLDPE) film;
the third polymer material comprises polyethylene (PE) film; and
the fourth polymer material comprises ethylene-vinyl alcohol (EVOH) film.

10. The laminate film of claim 8, wherein the color layer comprises a roto gravure print layer.

11. The laminate film of claim 10, wherein the color layer comprises between 1 and 10 colors.

12. The laminate film of claim 11, wherein the color layer comprises between 4 colors and 7 colors.

13. The laminate film of claim 8, wherein the tie layer comprises maleic-anhydride grafted polymer.

14. The laminate film of claim 8, wherein at least one of the first polymer material, the second polymer material, or the third polymer comprise a compatibilizer.

15. The laminate film of claim 14, wherein:
the compatibilizer comprises an anhydride and/or carboxylic acid functionalized ethylene/alpha-olefin interpolymer; and
the laminate film is recyclable.

16. A recycle ready laminate pouch for packaging liquid and viscous food and non-food products, comprising:
a pouch formed by bonding at least two panels around the panel edges with a bottom edge of the pouch formed by aligning bottom edges of the panels;
a pair of aligned side edges extending between the bottom edge and an upper edge opposite the bottom edge;
a pair of side seals sealing the pair of side edges to form a pouch body;
a pair of upper seals extending across the upper edge, each upper seal having one end adjacent each side seal and an opposite end adjacent a central portion of the pouch panel; and
an opening device integrally formed in the central portion of the pouch body for accessing the liquid and viscous food and non-food products contained within the pouch.

17. The pouch of claim 16, wherein the opening device is a fitment having a spout and a cap attachable to the spout.

18. The pouch of claim 16, wherein recycle ready laminate comprises a multi-layer structure, comprising:
a print web, comprising:
at least a first polymer layer comprising a first polyethylene material; and
at least one color layer;
a sealant web, comprising:
at least a second polymer layer comprising a polar material;
at least a third polymer layer comprising a second polyethylene material; and
at least one tie layer; and
an adhesive layer positioned between the print web and the sealant web, wherein the adhesive layer adheres the print web to the sealant web.

19. The pouch of claim 18, wherein:
the print web further comprises a primer layer applied to a bottom surface of the first polymer layer; and
the sealant web further comprises at least a fourth polymer layer comprising a third polyethylene material.

20. The pouch of claim 18, wherein:
the first polyethylene material comprises a bi-axially oriented polyethylene film;
the second polyethylene material comprises a linear low-density polyethylene film;
the third polyethylene material comprises a polyethylene film; and
the polar material comprises an ethylene-vinyl alcohol film.

21. The pouch of claim 18, wherein one or more of the first polyethylene material, the second polyethylene material, the third polyethylene material, or the polar material comprise a compatibilizer.

22. The pouch of claim 21, wherein the compatibilizer comprises an anhydride and/or carboxylic acid functionalized ethylene/alpha-olefin interpolymer.

23. The pouch of claim 22, wherein the pouch is recyclable.
